(19) United States
(12) Patent Application Publication
(10) Pub. No.: US 2007/0140732 A1
(43) Pub. Date: Jun. 21, 2007

(54) Methods for printer cartridge modification

(75) Inventors: James H. Jones, Fayetteville, NC (US); Donald R. Huck, Raleigh, NC (US); James R. Williams, Sims, NC (US); Andrew D. Scott, Robbins, NC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 11/300,992

(22) Filed: Dec. 15, 2005

(51) Int. Cl. G03G 15/00

(52) U.S. Cl. 399/109

(57) ABSTRACT

Techniques are provided for modifying a printer cartridge intended for installation in one type of printer to be installed in another type of printer or a plurality of printers. In one aspect, a method of modifying a toner cartridge may include modifying one or more end caps of the toner cartridge. In another aspect, a method of modifying a toner cartridge may include replaced one or more end caps of the toner cartridge with replacement end caps.

### BACKGROUND

The present invention relates to remanufacturing and modifying imaging process cartridges, such as printer toner cartridges, and more particularly to techniques for modifying an imaging process cartridge intended to operate in one type of imaging device, such as a printer, to operate in additional types of imaging devices.

In the printing industry, there is a growing market for the remanufacture and refurbishing of various types of imaging components such as toner cartridges, ink cartridges, magnetic rollers, seals, and the like. Toner cartridges, once spent, are unusable for their originally intended purpose. Without a refurbishing process, they would simply be discarded, even though the cartridge itself may still have potential life. As a result, techniques have been developed specifically to address this issue. These processes may entail, for example, the disassembly of the various structures of the cartridge, replacing toner, cleaning, adjusting or replacing any worn components and reassembling the cartridge.

The differences between printer cartridges for various types of printing devices may only be slight or subtle. In many instances it may only be an indentation or protuberance in the body of the cartridge. In other cases it may be not only a physical attribute of the body of the cartridge, but also the addition of a communications device. Certain style cartridges may be plentiful and relatively inexpensive simply because of certain factors such as the supply in the market or initial cost while other style cartridges may not be available in quantity or too expensive for cost effective use in remanufacturing. The easiest and most economic solution would be to simply convert the inexpensive style cartridges into the more costly style cartridge in order to meet this market demand. Additionally, it would be desirable to convert a cartridge into a type of cartridge that can be used in many different printer types.

### SUMMARY

In accordance with an embodiment of the present invention, techniques are provided for modifying a printer cartridge intended to operate in one type of printer to operate in another type of printer or operate in a plurality of types of printers.

In one aspect of the present invention, a method of modifying an imaging process cartridge, the imaging process cartridge sized to be installed in a first type of imaging device and not sized to be installed in a second type of imaging device, includes: providing the imaging process cartridge comprising a cartridge body and a gear side end plate attached to the cartridge body, said gear side end plate comprising a generally elongated shape having a generally curved first end, a generally planar second end and a limiting projection element disposed substantially equidistant the first end and the second end, the limiting projection element extending outward from said gear side end plate; removing the gear side end plate from the cartridge body; providing a replacement gear side end plate comprising a generally longitudinal shape having a generally curved first end and a generally planar second end, the replacement gear side end plate not comprising a limiting projection element disposed substantially equidistant the first end and the second end; and attaching the replacement gear side end plate to the cartridge body to form a modified imaging process cartridge.

In another aspect of the present invention, a method of modifying an imaging process cartridge, the imaging process cartridge sized to be installed in a first type of imaging device and not sized to be installed in a second type of imaging device, includes: providing the imaging process cartridge comprising a cartridge body and a gear side end plate attached to the cartridge body, the gear side end plate comprising a generally elongated shape having a generally curved first end, a generally planar second end and a limiting projection element disposed substantially equidistant the first end and the second end, the limiting projection element extending outward from said gear side end plate; and removing said limiting projection element extending outward from said gear side end plate and disposed substantially equidistant the first end and the second end to form a modified imaging process cartridge, said modified imaging process cartridge sized to be installed in both the first type of imaging device and the second type of imaging device

A more complete understanding of the present invention, as well as further features and advantages of the invention, will be apparent from the following detailed description and the accompanying drawings.

### BRIEF DESCRIPTION OF THE DRAWINGS

FIG. 1 shows a perspective view of a first prior art toner cartridge with the gear side in the foreground;

FIG. 2 shows a perspective view of a second prior art toner cartridge with the contact side in the foreground;

FIG. 3 shows a frontal view of the gear side end cap of the first prior art toner cartridge;

FIG. 4 shows a frontal view of a universal gear side end plate in accordance with the present invention;

FIG. 5 shows a rear view of the universal gear side end plate of FIG. 4 in accordance with the present invention;

FIG. 6 shows a frontal view of the contact side end plate of the second prior art toner cartridge;

FIG. 7 shows a rear view of the contact side end plate of the second prior art toner cartridge; and

FIG. 8 shows a frontal view of a universal contact side end plate in accordance with the present invention.

### DETAILED DESCRIPTION

The following detailed description of preferred embodiments refers to the accompanying drawings which illustrate specific embodiments of the invention. In the discussion that follows, specific techniques for converting an imaging process cartridge, such as a toner printer cartridge, for installation into one or more different types of printers are disclosed. Other embodiments having different structures and operations for the conversion of other types of cartridges for use with other types of printers do not depart from the scope of the present invention.

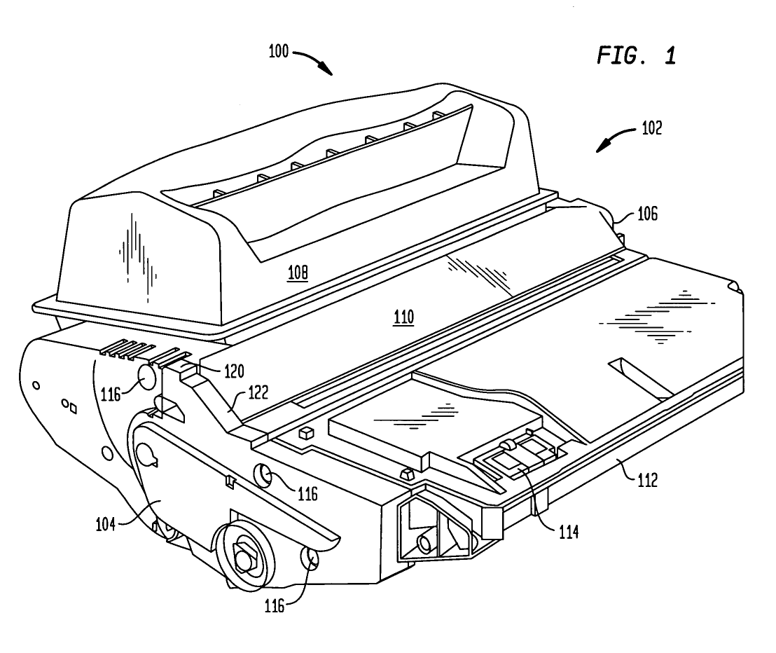

FIG. 1 shows a perspective view of a prior art toner cartridge 100, specifically a cartridge suitable for use in an HP4300 laser printer. The cartridge 100 includes a cartridge body 102 attached to a gear side end plate 104 and a contact side end plate 106. The gear side end plate 104 is attached to the cartridge body 102 by a plurality of screws 116. The gear side end plate includes a limiting projection element 120 and a slide-shaped member 122. The cartridge body 102 includes a toner hopper portion 108, a magnetic roller holding portion 110 and a waste bin portion 112. The cartridge 100 also includes an electronic circuit 114 adapted for communication with the printer when the toner cartridge 100 is installed in the printer.

Other types of laser printers, such as the HP4250 and HP4350 laser printers, for example, utilize a toner cartridge with many similarities, but also with one or more differences which prevent an unmodified HP4300 toner cartridge from being installed or operating in such other printers. Certain modifications can be made to HP4300 toner cartridge to allow the modified toner cartridge to be installed in additional printer types.

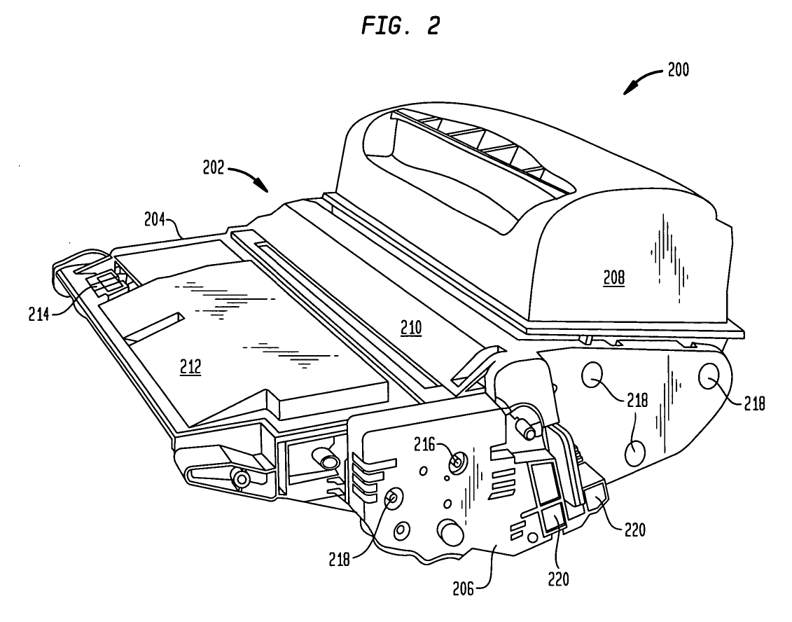

FIG. 2 shows a perspective view of a prior art toner cartridge 200, specifically a cartridge suitable for use in an HP4350 laser printer. The cartridge 200 includes a cartridge body 202 attached to a gear side end plate 204 and a contact side end plate 206. The contact side end plate 206 is attached to the cartridge body 202 by screws 216 and welds 218, and includes copper contacts 220 for receiving signals from the printer. The cartridge body 202 includes a toner hopper portion 208, a magnetic roller holding portion 210 and a waste bin portion 212. The cartridge 100 also includes an electronic circuit 214 adapted for communication with the printer when the toner cartridge 200 is installed in the printer.

Other types of laser printers, such as the HP4200, HP4300 and HP4345 laser printers, utilize a toner cartridge with many similarities, but also with a few important differences which prevent an unmodified HP4350 toner cartridge from operating in such other printers. Certain modifications can be made to HP4350 toner cartridge to allow the modified toner cartridge to be installed in additional printer types

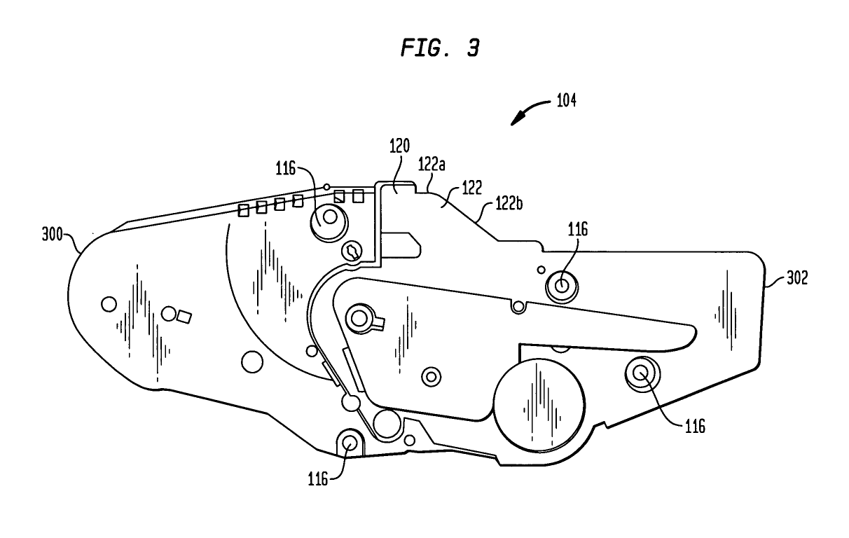

FIG. 3 shows a front view of the gear side end plate 104 of the toner cartridge 100. The gear side end plate 104 is generally elongated in shape and has a generally curved end 300 and a generally planar end 302. The limiting projection element 120 is disposed substantially equidistant the generally curved end 300 and the generally planar end 302. As seen in FIGS. 1 and 3, the limiting projection element 120 is generally rectangular in shape and extends outward from the gear side end plate 104. The slide-shaped member 122 is adjacent to the limiting projection element 120 and comprises a horizontal wall 122a and an angled portion 122b. The limiting projection element 120 and the slide-shaped member 122 of the toner cartridge 100 prevent the toner cartridge 100, intended for use in the HP 4300 type of printer, from being installed in other printer types, such as the HP 4250 and the HP 4350, for example.

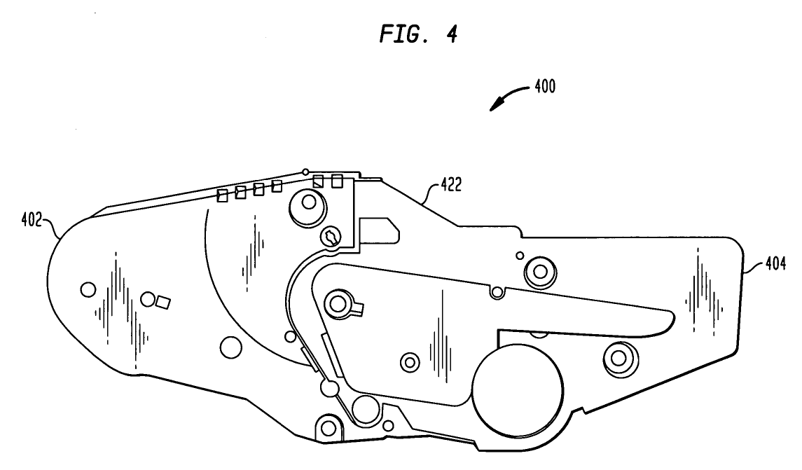

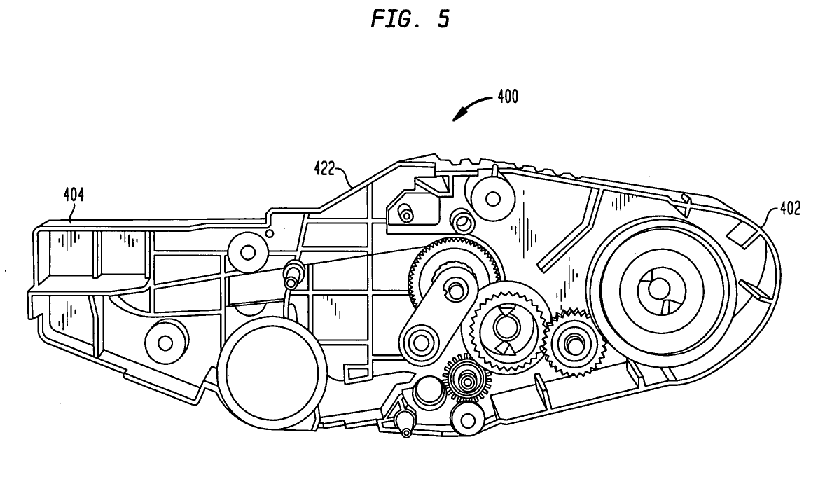

FIGS. 4 and 5 show respectively a frontal view and a rear view of a universal gear side end plate 400 in accordance with the present invention. As described in greater detail below, the universal gear side end plate 400 may be formed by fabricating a new universal gear side end plate or modifying an existing gear side end plate 104. The universal gear side end plate 400 is generally elongated in shape and has a generally curved end 402 and a generally planar end 404. Unlike the gear side end plate 104, the universal gear side end plate 400 does not include the limiting projection element 120. Additionally, the universal gear side end plate 400 includes a modified slide-shaped member 422 which does not extend as far outward as the slide-shaped member 122. FIG. 5 also shows a plurality of axle rods and gears attached to the axle rods.

By removing the gear side end plate 104 from the toner cartridge 100 and replacing it with the universal gear side end plate 400, the toner cartridge 100 may be modified to allow the toner cartridge 100 to be installed in additional types of printers. The gear side end plate 104 may be removed by unscrewing the screws 116 described above. Additionally, to ensure that the toner cartridge 100 with the universal gear side end plate 400 is readily installed in the additional printer types, it may be desirable to remove a small portion of the toner cartridge 100 in the area adjacent where the limiting projection element 120 and the slide-shaped member 122 were located prior to the installation of the universal gear side end plate 400. This area may be removed with a file, knife, or other type of cutting tool, for example. Additionally, the electronic circuit 114, which was adapted for communication with only the first printer type, may be replaced with a replacement electronic circuit which is adapted for use with all the printer types. The replacement electronic circuit may be PrintDetect™ chip available from Static Control Components, Inc.

The universal gear side end plate 400 may be formed by fabricating, by injection molding for example, a new end plate conforming to the size requirements of the universal gear side end plate 400. Alternatively, the gear side end plate 104 may removed from the toner cartridge 100 and modified to form the universal gear side end plate 400. To perform such a modification, the limiting projection element 120 and a portion of the slide-shaped member 122 should be removed. The removal of these portions may be accomplished by using a knife, a RotoZip® cutter or the like, for example. To ensure an accurate cut, a jig may be used to correctly position and guide the RotoZip® cutter along a guide path to perform this removal.

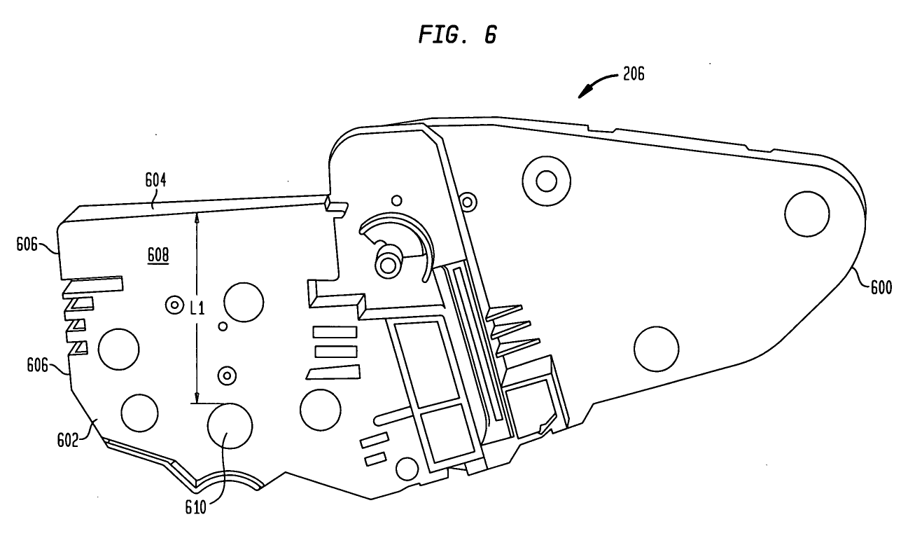

FIG. 6 shows a frontal view of the contact side end plate 206 of the toner cartridge 100. The contact side end plate 206 is generally elongated in shape and has a generally curved end 600 and a generally planar end 602. The generally planar end 602 comprises a first wall 604 and a second wall 606 intersecting at substantially right angles. A third wall 608 located at substantially right angles to the first wall 604 and the second wall 606 includes an aperture 610 adapted for holding the axle of an organic photoconductor (OPC) drum. The aperture 610 is located at a first predetermined distance L1 from the first wall 604. The first wall 604 and portions of the second wall 606 and third wall 608 of the toner cartridge 200 prevent the toner cartridge 200, intended for use in the HP 4350 type of printer, from being installed in other printer types, such as the HP 4300 and the HP 4345, for example.

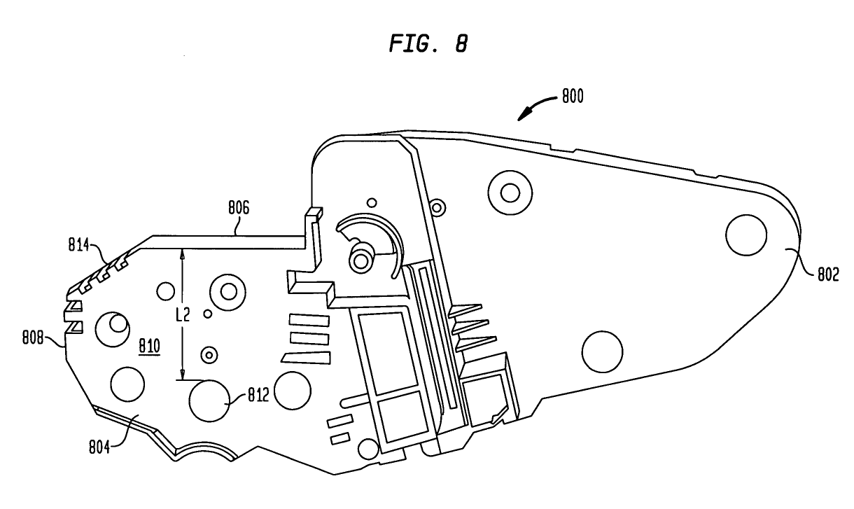

FIG. 8 shows a frontal view and a universal contact side end plate 800 in accordance with the present invention. As described in greater detail below, the universal contact side end plate 800 may be formed by fabricating a new universal contact side end plate or modifying an existing contact side end plate 206. The universal contact side end plate 800 is generally elongated in shape and has a generally curved end 802 and a generally planar end 804. The generally planar end 804 comprises a first wall 806 disposed at a substantially right angle to a second wall 808. A third wall 810 intersects, at substantially right angles, the first wall 806 and the second wall 808 and includes an aperture 812 adapted for holding the axle of an organic photoconductor (OPC) drum. The aperture 812 is located at a predetermined distance L2 from the first wall 806. The distance L2 is less than the distance L1. Unlike the contact side end plate 206, the first wall 806 and the second wall 808 of the universal contact side end plate 800 do not intersect. A diagonal member 814 connects the first wall 806 and the second wall 808. These differences from the contact side end plate 206 remove obstructions which prevent a cartridge utilizing the universal contact side end plate 800 to be installed in additional printer types.

By removing the contact side end plate 206 from the toner cartridge 200 and replacing it with the universal contact side end plate 800, the toner cartridge 200 may be modified to allow the toner cartridge 200 to be installed in additional types of printers. The contact side end plate 206 may be removed by breaking the welds 218, described above. Additionally, the electronic circuit 214, which was adapted for communication with only the first printer type, may be replaced with a replacement electronic circuit which is adapted for use with many printer types. The replacement electronic circuit may be PrintDetect™ chip available from Static Control Components, Inc.

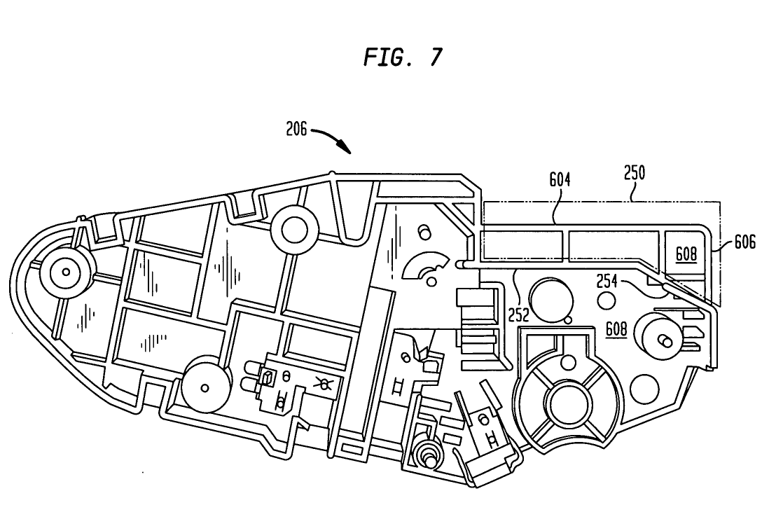

The universal contact side end plate 800 may be formed by fabricating, by injection molding for example, a new end plate conforming to the size requirements of the universal contact side end plate 800. Alternatively, the contact side end plate 206 may removed from the toner cartridge 200 and modified to form the universal contact side end plate 400. To perform such a modification, the first wall 604 and portions of the second wall 606 and the third wall 608 should be removed. The removal of these portions may be accomplished by using a knife, a RotoZip® cutter or the like, for example. To ensure an accurate cut, a jig may be used to correctly position and guide the RotoZip® cutter along a guide path to perform this removal. FIG. 7 shows a rear view of the contact side end plate 206 with the portion 250 to be removed indicated by dashed lines. This removal exposes the underlying walls 252 and 254 which become, respectively, the first wall 806 and the diagonal member 814 in the universal contact side end plate 800.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the Invention to the specific embodiments described herein.

What is claimed is:

1. A method of modifying an imaging process cartridge, the imaging process cartridge sized to be installed in a first type of imaging device and not sized to be installed in a second type of imaging device, the method comprising:
providing the imaging process cartridge comprising a cartridge body and a gear side end plate attached to the cartridge body, said gear side end plate comprising a generally elongated shape having a generally curved first end, a generally planar second end and a limiting projection element disposed substantially equidistant the first end and the second end, said limiting projection element extending outward from said gear side end plate;
removing the gear side end plate from the cartridge body;
providing a replacement gear side end plate comprising a generally longitudinal shape having a generally curved first end and a generally planar second end, said replacement gear side end plate not comprising a limiting projection element disposed substantially equidistant the first end and the second end; and
attaching the replacement gear side end plate to the cartridge body to form a modified imaging process cartridge.

2. The method of claim 1 further comprising:
removing a portion of the cartridge body in the area adjacent the location previously occupied by the limiting projection element, wherein said modified imaging process cartridge is sized to be installed in both the first type of imaging device and the second type of imaging device.

3. The method of claim 1 wherein the limiting projection element comprises a generally rectangular shape.

4. A method of modifying an imaging process cartridge, the imaging process cartridge sized to be installed in a first type of imaging device and not sized to be installed in a second type of imaging device, the method comprising:
providing the imaging process cartridge comprising a cartridge body and a gear side end plate attached to the cartridge body, said gear side end plate comprising a generally elongated shape having a generally curved first end, a generally planar second end and a limiting projection element disposed substantially equidistant the first end and the second end, said limiting projection element extending outward from said gear side end plate; and
removing said limiting projection element extending outward from said gear side end plate and disposed substantially equidistant the first end and the second end to form a modified imaging process cartridge, said modified imaging process cartridge sized to be installed in both the first type of imaging device and the second type of imaging device.

5. The method of claim 4 further comprising, before removing the limiting projection element:
removing the gear side end plate from the cartridge body.

6. The method of claim 5 further comprising, after removing said limiting projection element:
attaching the gear side end plate to the cartridge body.

7. A method of modifying an imaging process cartridge, the imaging process cartridge sized to be installed in a first type of imaging device and not sized to be installed in a second type of imaging device, the method comprising:
providing the imaging process cartridge comprising a cartridge body and a contact side end plate attached to the cartridge body, said contact side end plate comprising a generally elongated shape having a generally curved first end and a generally planar second end, said generally planar second end comprising a first wall and a second wall intersecting at right angles, said generally planar second end comprising an aperture in a third wall adapted for holding an axle of an organic photoconductor (OPC) drum and located at a first predetermined distance from the first wall;
removing the contact side end plate from the cartridge body;
providing a replacement contact side end plate comprising a generally longitudinal shape having a generally curved first end and a generally planar second end, said generally planar end of the replacement contact side end plate comprising a first wall and a second wall disposed at right angles and not intersecting, said generally planar second end of the replacement contact side end plate comprising an aperture in a third wall adapted for holding an axle of an organic photoconductor (OPC) drum located at a second predetermined distance from the first wall of the replacement contact side end plate, wherein said first predetermined distance is greater than said second predetermined distance; and
attaching the replacement contact side end plate to the cartridge body.

8. A method of modifying an imaging process cartridge, the imaging process cartridge sized to be installed in a first type of imaging device and not sized to be installed in a second type of imaging device, the method comprising:
providing the imaging process cartridge comprising a cartridge body and a contact side end plate attached to the cartridge body, said contact side end plate comprising a generally elongated shape having a generally curved first end and a generally planar second end, said generally planar second end comprising a first wall and a second wall intersecting at right angles, said generally planar second end comprising an aperture in a third wall adapted for holding an axle of an organic photoconductor (OPC) drum and located at a first predetermined distance from the first wall;
removing the first wall and a portion of the third wall to expose a fourth wall, at least of portion of the fourth wall parallel to the first wall prior to the removal of the first wall, wherein said aperture in the third wall adapted for holding the axle of the OPC drum is located at a second predetermined distance from the first wall, wherein said first predetermined distance is greater than said second predetermined distance;

9. The method of claim 7 further comprising:
removing a portion of the second wall.
